(19) United States
(12) Patent Application Publication
(10) Pub. No.: US 2025/0276571 A1
(43) Pub. Date: Sep. 4, 2025

(54) COOLING PANEL FOR BATTERY CASE

(71) Applicants: Hyundai Motor Company, Seoul (KR); Kia Corporation, Seoul (KR)

(72) Inventors: Kyung Mo Kim, Hwaseong (KR); Jong Gyu Park, Hwaseong (KR); Gun Woo Ko, Hwaseong (KR); Chan Sol Kim, Hwaseong (KR)

(21) Appl. No.: 18/815,509

(22) Filed: Aug. 26, 2024

(30) Foreign Application Priority Data
Feb. 29, 2024 (KR) 10-2024-0030039

(51) Int. Cl. B60K 1/04; B60K 1/00

(52) U.S. Cl. CPC B60K 1/04; B60K 2001/005

(57) ABSTRACT

Provided is a cooling panel for a battery case. The cooling panel is formed in a panel shape and has a first surface and a second surface parallel to each other, the cooling panel has a cooling flow passage formed therein and configured to allow refrigerant to flow therethrough, and the cooling flow passage has, based on a central portion between the first surface and the second surface, a flow cross-sectional area on a side close to the first surface and a flow cross-sectional area on a side close to the second surface, wherein the two flow cross-sectional areas have different configurations.

### CROSS-REFERENCE TO THE RELATED APPLICATION

This application claims under 35 U.S.C. § 119(a) the benefit of Korean Patent Application No. 10-2024-0030039, filed on Feb. 29, 2024, in the Korean Intellectual Property Office, the disclosure of which is incorporated herein by reference in its entirety.

### BACKGROUND

### Technical Field

The present disclosure relates to a structure of a battery case mounted in a vehicle.

### Background

An electric vehicle has a battery pack within it, mounted therein and configured to supply power to a motor that generates the vehicle's driving force.

The battery pack is configured to accommodate a plurality of battery modules in a battery case, and each of the battery modules is formed by overlapping a plurality of battery cells.

The battery case is formed of a lower case and an upper case. Here, the lower case surrounds the lower side surface and the side surface of each of the battery modules accommodated in the battery case, while the upper cover seals the top of the lower case to enable watertightness of the battery modules within.

Since the battery modules need to be cooled, it is necessary for the battery case to have a structure related to cooling performance.

The battery modules accommodated in the battery case may have different types of battery cells and various configurations. In this manner, battery modules with various characteristics may be accommodated in the battery case. Here, as described above, the battery case is required to provide optimized cooling performance for the battery modules with various characteristics.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Therefore, the present disclosure has been made in view of the above problems, and it is an object of the present disclosure to provide a cooling panel for a battery case configured to provide optimized cooling performance for battery modules that have various characteristics and are accommodated in the battery case without requiring replacement of cooling-related components, thereby making it possible to significantly reduce manufacturing costs of the battery base.

In accordance with the present disclosure, the above and other objects can be accomplished by the provision of a cooling panel for a battery case, comprising a first surface and a second surface parallel to each other, a cooling flow passage configured to allow the flow of refrigerant inside. The cooling flow passage has, based on a central portion between the first surface and the second surface, a first flow cross-sectional area on one side close to the first surface and a second flow cross-sectional area on the other side close to the second surface, wherein the two flow cross-sectional areas are different.

The cooling flow passage may be formed with a first flow passage portion closed to the first surface and a second flow passage portion closed to the second surface, the first flow passage portion and the second flow passage portion being interconnected.

The first flow passage portion may have a width equal to or less than a width of the second flow passage portion. The first flow passage portion of the cooling flow passage may have the width equal to or less than 60% of the width of the second flow passage portion of the cooling flow passage.

A difference between a thickness of the first flow passage portion and a thickness of the second flow passage portion may be less than 10%.

The first flow passage portion may communicate with a central portion in a width direction of the second flow passage portion.

The cooling flow passage may have, based on the central portion between the first surface and the second surface, a first independent flow passage on one side close to the first surface and a second independent flow passage on the other side close to the second surface.

The first independent flow passage may have a width equal to or less than a width of the second independent flow passage, and a parallel partition wall parallel to the first surface or the second surface may be provided between the first independent flow passage and the second independent flow passage.

The first independent flow passage may have a width narrowly formed to be equal to or less than 60% of a width of the second independent flow passage.

The first independent flow passage may be aligned with a central portion in a width direction of the second independent flow passage.

The parallel partition wall may be formed so that the region where the first independent flow passage is located protrudes into the interior of the second independent flow passage.

The cooling flow passage may be formed with a center flow passage and a side flow passage, wherein a distance between the center flow passage and the first surface and a distance between the center flow passage and the second surface may be equal to each other, and the side flow passage may be located next to the center flow passage and may be formed at a position closer to the second surface than to the first surface.

The side flow passage may be provided in multiple, and the side flow passages may be respectively disposed on opposite sides of the center flow passage with the center flow passage interposed therebetween.

The center flow passage may have a thickness greater than a thickness of the side flow passage. The center flow passage may have a thickness at least 1.8 times greater than a thickness of the side flow passage.

A thickness of a vertical partition wall formed between the center flow passage and the side flow passage may be formed to be thinner than a thickness of the center flow passage and a thickness of the side flow passage.

The cooling panel may be formed of an extruded material having a uniformly extruded cross-sectional shape of the cooling flow passage.

Also provided is a vehicle comprising the battery case.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a state in which battery modules are accommodated in a battery case to which a cooling panel according to the present disclosure is applied;

FIG. 2 is a cross-sectional view taken along line II-II in FIG. 1;

FIG. 3 is view showing a lower case in which the battery modules in FIG. 1 are removed;

FIG. 4 is a view showing a structure of the cooling panel in FIG. 3;

FIG. 5 is a view showing a state in which the cooling panel in FIG. 4 is vertically inverted;

FIG. 6 is a cross-sectional view corresponding to the cross-sectional view in FIG. 2 and showing the battery case to which the cooling panel in FIG. 5 is applied;

FIG. 7 is a detailed view showing a cooling flow passage of a first embodiment formed in the cooling panel in FIG. 5;

FIG. 8 is a view showing a second embodiment of the cooling flow passage of the cooling panel of the present disclosure; and

FIG. 9 is a view showing a third embodiment of the cooling flow passage of the cooling panel of the present disclosure.

### DETAILED DESCRIPTION

Hereinafter, the present disclosure will be described in detail through preferred embodiments thereof with reference to the accompanying drawings. Wherever possible, the same reference numbers will be used throughout the drawings to refer to the same or like parts, and redundant descriptions thereof will be omitted.

In describing the embodiments disclosed herein, when it is determined that a detailed description of publicly known techniques to which the disclosure pertains may obscure the gist of the present disclosure, the detailed description will be omitted. Further, it should be understood that the accompanying drawings are merely illustrated to easily describe the embodiments disclosed in this specification, and therefore, the technical idea disclosed in this specification is not limited by the accompanying drawings. Further, it should be noted that the accompanying drawings include all modifications, equivalents, and substitutes that fall within the spirit and technical scope of the present disclosure.

Meanwhile, in the present disclosure, terms such as “first” and/or “second” may be used to describe various components, but the components are not limited by the terms. The terms are used only for the purpose of distinguishing one component from other components.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

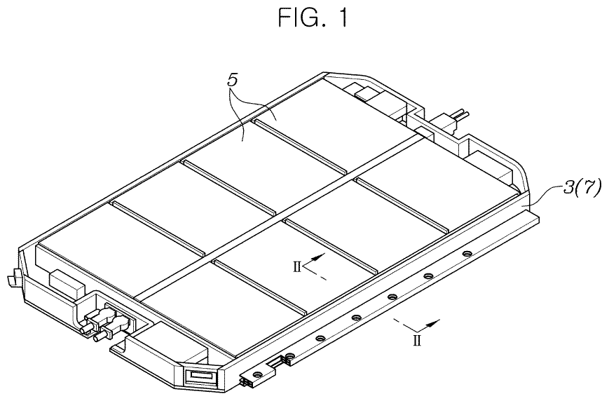

FIG. 1 is a view showing a state in which battery modules 5 are accommodated in a battery case 3 to which a cooling panel 1 according to the present disclosure is applied. Here, a plurality of battery modules 5 are accommodated in a lower case 7 serving as a part of the battery case 3, and an upper cover is not shown in the drawing.

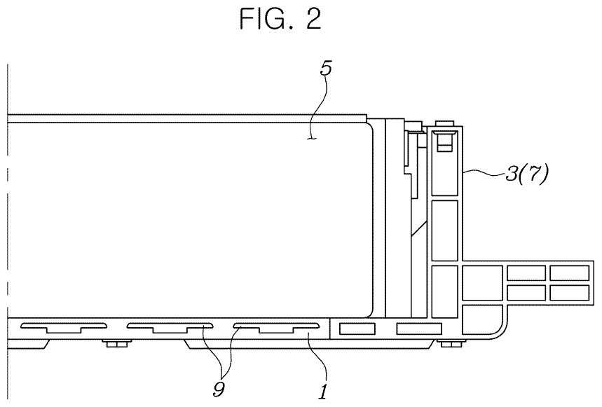

FIG. 2 is a cross-sectional view taken along line II-II in FIG. 1. Here, FIG. 2 shows a cross section of the cooling panel 1 that is located at the lower side of the battery modules 5 and includes a cooling flow passage 9 of the present disclosure.

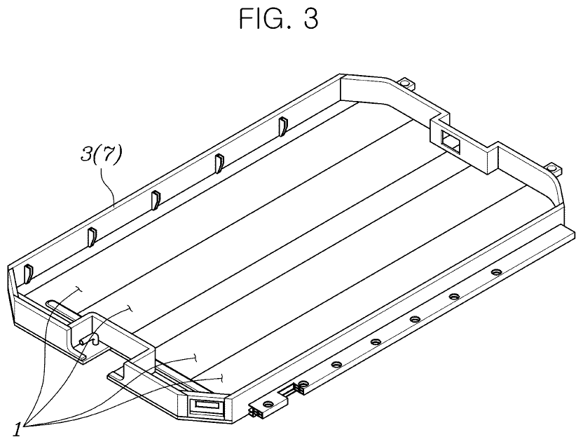

FIG. 3 is a view showing the lower case 7 in which the battery modules 5 shown in FIG. 1 are removed. Here, one or more cooling panels 1 of the present disclosure are connected to each other so as to form the bottom surface of the lower case 7.

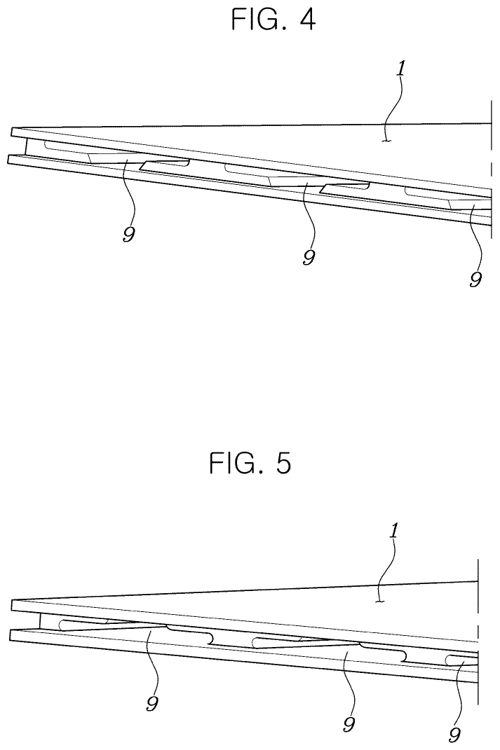

FIG. 4 is a view showing a structure of the cooling panel 1 in FIG. 3. Here, the cooling flow passage 9 provided in the cooling panel 1 is formed to have an upper side width wider than a lower side width.

FIG. 5 is a view showing a state in which the cooling panel 1 in FIG. 4 is vertically inverted. Here, the cooling flow passage 9 provided in the cooling panel 1 is formed to have an upper side width narrower than a lower side width.

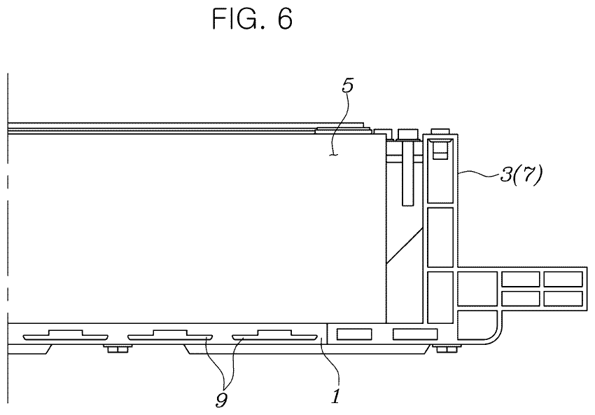

FIG. 6 is a cross-sectional view corresponding to the cross-sectional view in FIG. 2 and showing the battery case 3 to which the cooling panel 1 in FIG. 5 is applied. Here, the cross-sectional shape of the cooling flow passage inside the cooling panel 1 is different from that of FIG. 2 in that the upper side width is formed to be narrower than the lower side width.

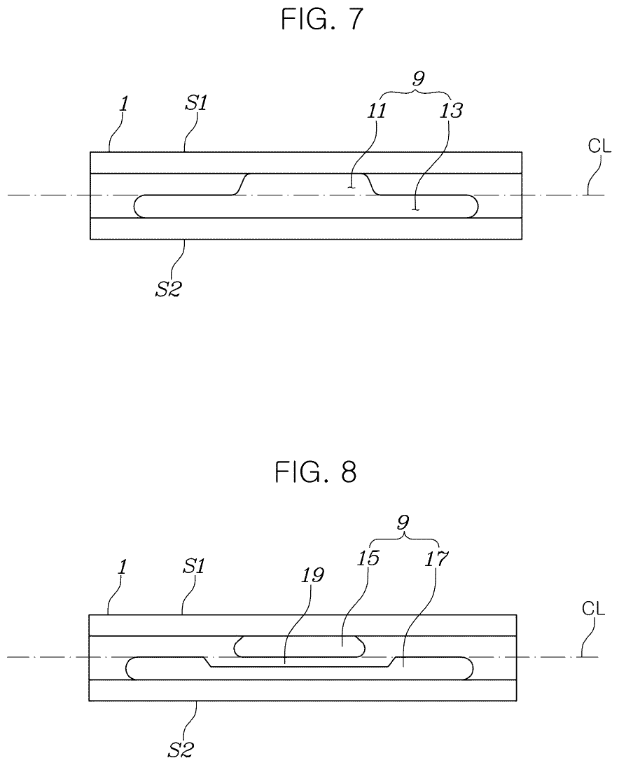

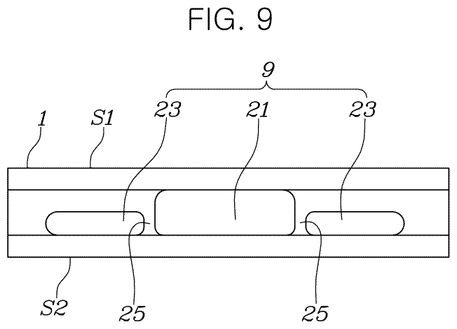

FIG. 7 is a detailed view showing the cooling flow passage 9 formed in the cooling panel 1 in FIG. 5, FIG. 8 is a view showing a second embodiment of the cooling flow passage 9 formed in the cooling panel 1 of the present disclosure, and FIG. 9 is a view showing a third embodiment of the cooling flow passage 9 formed in the cooling panel 1 of the present disclosure.

Referring to FIGS. 7 and 8, embodiments of the cooling panel for the battery case of the present disclosure are commonly formed in a panel shape having a first surface S1 and a second surface S2 parallel to each other, and the cooling flow passage 9 through which refrigerant flows is formed in the cooling panel 1. Further, the cooling flow passage 9 has a first flow cross-sectional area on one side close to the first surface S1 and a second flow cross-sectional area on the other side close to the second surface S2, based on a central portion, such as a central line (CL), between the first surface S1 and the second surface S2. These two flow cross-sectional areas are different.

First, in the first embodiment in FIG. 7, the cooling flow passage 9 has a constant cross-sectional shape. Further, the cooling flow passage 9 has a first flow passage portion 11 disposed close to the first surface S1 and a second flow passage portion 13 disposed close to the second surface S2. The first flow passage portion 11 and the second flow passage portion 13 communicate with each other, and a width of the first flow passage portion 11 is narrower than a width of the second flow passage portion 13.

The structure of the cooling flow passage 9 is also shown in FIGS. 5 and 6. As shown in FIG. 6, the first flow passage portion 11 is located closer to the battery module 5 than the second flow passage portion 13.

In contrast, in the structure of the cooling flow passage 9 shown in FIGS. 2 and 4, the second flow passage portion 13 is located closer to the battery module 5 than the first flow passage portion 11. This arrangement may be achieved by simply vertically inverting the cooling panel 1.

In the structure of the cooling flow passage 9 shown in FIGS. 2 and 4, the wider second flow passage portion 13 is located close to the battery module 5. Accordingly, this structure is desirably used to cool the battery module 5 having a characteristic of requiring rapid dissipation of a relatively large amount of heat.

In addition, in the structure of the cooling flow passage 9 shown in FIGS. 5 and 6, the narrower first flow passage portion 11 is located close to the battery module 5. Accordingly, this structure is desirably used to cool the battery module 5 having a characteristic of requiring dissipation of a relatively small amount of heat.

When the battery case 3 is formed as described above, the cooling panel 1 of the present disclosure may provide optimized cooling performance by vertically inverting its arrangement. This takes into account the required cooling characteristics of the battery modules 5 accommodated in the battery case 3.

In other words, according to the present disclosure, it is possible to accommodate battery modules requiring various types of cooling performance without requiring additional components. By simply changing the arrangement direction of the cooling panel 1, the required cooling performance can be provided based on the characteristics of the battery modules. This approach can significantly reduce manufacturing costs by decreasing the number of molds needed to manufacture battery cases.

In the cooling flow passage 9 of the first embodiment in FIG. 7, the width of the first flow passage portion 11 is formed to be equal to or less than 60% of the width of the second flow passage portion 13, and a difference between a thickness of the first flow passage portion 11 and a thickness of the second flow passage portion 13 is desirably formed to be less than 10%.

In this manner, cooling is performed in a different manner depending on the installation direction of the cooling flow passage 9.

In the structure according to the embodiment, the first flow passage portion 11 communicates with a central portion in the width direction of the second flow passage portion 13.

For reference, in the case of the structure of the cooling flow passage 9 shown in FIGS. 7 to 9, the multiple cooling flow passages 9 are formed uniformly throughout the entire range of the cooling panel in units shown in each drawing.

In the second embodiment shown in FIG. 8, the cooling flow passage 9 includes a first independent flow passage 15 located near the first surface S1 and a second independent flow passage 17 located near the second surface S2, based on a central portion between the first surface S1 and the second surface S2.

That is, in this embodiment, the first independent flow passage 15 and the second independent flow passage 17 are disposed so as to overlap each other in the thickness direction of the cooling panel 1, thereby sufficiently securing a difference in cooling performance between the first surface S1 and the second surface S2.

The first independent flow passage 15 is formed to have a narrower width than that of the second independent flow passage 17, and a parallel partition wall 19 parallel to the first surface S1 or the second surface S2 is provided between the first independent flow passage 15 and the second independent flow passage 17.

In this manner, when the first independent flow passage 15 and the second independent flow passage 17 are separately formed by the parallel partition wall 19, it is may prevent generation of vortices at an interface due to a difference in width of the flow passage as in the first embodiment. Additionally, this configuration reduces the differential pressure between the supply and recovery sides of the refrigerant and allows for equal control of the flow rate by avoiding flow rate interference.

The width of the first independent flow passage 15 is formed to be equal to or less than 60% of the width of the second independent flow passage 17, and the first independent flow passage 15 is aligned with a central portion in the width direction of the second independent flow passage 17.

In addition, in the present embodiment, the parallel partition wall 19 is formed so that the region where the first independent flow passage 15 is located protrudes into the interior of the second independent flow passage 17. In this manner, it is possible to secure a sufficient thickness of the first independent flow passage 15.

The cooling flow passage 9 of the third embodiment in FIG. 9 includes a center flow passage 21, in which a distance between the center flow passage 21 and the first surface S1 and a distance between the center flow passage 21 and the second surface S2 are equal to each other, and a side flow passage 23 located next to the center flow passage 21 and formed at a position closer to the second surface S2 than to the first surface S1.

In the present embodiment, the side flow passages 23 are respectively disposed at opposite sides of the center flow passage 21. The center flow passage 21 has a thickness formed to be at least 1.8 times greater than a thickness of the side flow passage 23, creating an appropriate difference in cooling performance between the first surface S1 and the second surface S2.

A thickness of a vertical partition wall 25 provided between the center flow passage 21 and the side flow passage 23 is formed to be thinner than the thickness of the center flow passage 21 and the thickness of the side flow passage 23, thereby forming one cooling flow passage set. Here, these cooling flow passage sets are uniformly distributed throughout the cooling panel 1.

In this manner, when the center flow passage 21 and the side flow passage 23 each having a different thickness and a different distance from the first surface S1 are partitioned from each other by the vertical partition wall 25, it may prevent the generation of vortices at an interface due to a difference in flow passage width as in the first embodiment. As a result, this reduces differential pressure between the supply side and the recovery side of the refrigerant. This advantage prevents flow rate interference and enables uniform control of flow rates as in the second embodiment.

For reference, the cooling panel 1 is preferably formed of an extruded material having a uniformly extruded cross-sectional shape of the cooling flow passage 9.

The battery case 3 shown in FIG. 3 may be formed using at least one of the cooling panels 1 as described above.

In this case, to ensure the cooling performance of the battery case 3 meets the cooling performance required by the battery module 5, the first surface S1 or the second surface S2 of the cooling panel 1 may be assembled in a direction of contacting the surface of the battery module 5.

In this manner, the cooling panel 1 of the present disclosure may differentiate cooling performance of the battery module 5 by vertically inverting the arrangement direction of the cooling panel 1, thereby making it possible to easily and inexpensively produce the battery case 3 capable of accommodating various battery modules 5 requiring various levels of cooling performance.

As is apparent from the above description, the present disclosure provides the following effects.

First, it is possible to provide optimized cooling performance for battery modules that have various characteristics and are accommodated in a battery case.

Additionally, since replacement of cooling-related components is not required, manufacturing costs of the battery case may be significantly reduced.

Although the preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. A cooling panel for a battery case, comprising:
a first surface and a second surface parallel to each other; and
a cooling flow passage configured to allow the flow of refrigerant inside,
wherein the cooling flow passage comprises, based on a central portion between the first surface and the second surface, a first flow cross-sectional area on one side close to the first surface and a second flow cross-sectional area on the other side close to the second surface, and
wherein the two flow cross-sectional areas are different.

2. The cooling panel according to claim 1, wherein:
the cooling flow passage is formed with a constant cross-sectional shape along the longitudinal direction of the cooling panel, with a first flow passage portion closed to the first surface and a second flow passage portion closed to the second surface, the first flow passage portion and the second flow passage portion being interconnected.

3. The cooling panel according to claim 2, wherein the first flow passage portion has a width equal to or less than a width of the second flow passage portion.

4. The cooling panel according to claim 3, wherein the first flow passage portion of has a width equal to or less than 60% of a width of the second flow passage portion.

5. The cooling panel according to claim 2, wherein a difference between a thickness of the first flow passage portion and a thickness of the second flow passage portion is less than 10%.

6. The cooling panel according to claim 2, wherein the first flow passage portion communicates with a central portion in a width direction of the second flow passage portion.

7. The cooling panel according to claim 1, wherein the cooling flow passage comprises, based on the central portion between the first surface and the second surface, a first independent flow passage on one side close to the first surface and a second independent flow passage on the other side close to the second surface.

8. The cooling panel according to claim 7, wherein:
the first independent flow passage has a width equal to or less than a width of the second independent flow passage; and
a partition wall parallel to the first surface or the second surface is provided between the first independent flow passage and the second independent flow passage.

9. The cooling panel according to claim 8, wherein the first independent flow passage has a width equal to or less than 60% of a width of the second independent flow passage.

10. The cooling panel according to claim 8, wherein the first independent flow passage is aligned with a central portion in a width direction of the second independent flow passage.

11. The cooling panel according to claim 8, wherein the partition wall is formed so that the region where the first independent flow passage is located protrudes into the interior of the second independent flow passage.

12. The cooling panel according to claim 1, wherein the cooling flow passage is formed with a center flow passage and a side flow passage, wherein a distance between the center flow passage and the first surface and a distance between the center flow passage and the second surface are equal to each other, and the side flow passage is located next to the center flow passage and is formed at a position closer to the second surface than to the first surface.

13. The cooling panel according to claim 12, wherein the side flow passage is provided in multiple, and the side flow passages are respectively disposed on opposite sides of the center flow passage with the center flow passage interposed therebetween.

14. The cooling panel according to claim 12, wherein the center flow passage has a thickness greater than a thickness of the side flow passage.

15. The cooling panel according to claim 14, wherein the center flow passage has a thickness at least 1.8 times greater than a thickness of the side flow passage.

16. The cooling panel according to claim 15, wherein a thickness of a vertical partition wall formed between the center flow passage and the side flow passage is formed to be thinner than a thickness of the center flow passage and a thickness of the side flow passage.

17. The cooling panel according to claim 1, wherein the cooling panel is formed of an extruded material having a uniformly extruded cross-sectional shape of the cooling flow passage.

18. A battery case comprising the cooling panel according to claim 1.

19. The battery case according to claim 18, wherein the first surface or the second surface of the cooling panel is disposed to contact a surface of a battery module accommodated in the battery case.

20. A vehicle comprising the battery case of claim 18.
